(19) United States
(12) Patent Application Publication
(10) Pub. No.: US 2015/0137561 A1
(43) Pub. Date: May 21, 2015

(54) COMPOSITE COMPONENT FOR A MOTOR VEHICLE BODY

(71) Applicant: GM GLOBAL TECHNOLOGY OPERATIONS LLC, Detroit, MI (US)

(72) Inventor: Michael Kuepper, Hofheim am Taunus (DE)

(21) Appl. No.: 14/546,807

(22) Filed: Nov. 18, 2014

(30) Foreign Application Priority Data
Nov. 18, 2013 (DE) 102013019387.7

(51) Int. Cl. B62D 29/00; B62D 25/02

(52) U.S. Cl. CPC B62D 29/001; B62D 25/025
USPC 296/209; 428/457; 428/174

(57) ABSTRACT

A roll-formed composite component for a motor vehicle body is disclosed, which includes a light metal layer, a steel sheet layer and an adhesive layer electrically insulating the light metal layer and the steel sheet layer against one another. The composite component can, on its own or together with other components, form a sill in a motor vehicle body.

### CROSS REFERENCE TO RELATED APPLICATION

This application claims priority to German Patent Application No. 102013019387.7 filed Nov. 18, 2013, which is incorporated herein by reference in its entirety.

### BACKGROUND

In order to be able to comply with ever more stringent legal requirements in terms of fuel consumption, motor vehicle manufacturers are forced to intensively find possibilities of reducing the weight of the vehicles. Since such a weight reduction may not be traded for a reduction of the mechanical load capacity of the bodies of the motor vehicles and consequently with deductions in the safety of the vehicle occupants, there is a substantial interest in composite materials which promise potential for further weight reduction in motor vehicle manufacture.

DE 10 2011 001 849 A1 discloses a composite component for a motor vehicle body, which is produced by gluing together two sheet metal blanks and forming the composite work pieces thus obtained in a press. Forming in such a press mostly includes stretching the material of the sheets glued to one another. When, through this stretching, the adhesive layer between the metal sheets is broken and these come into galvanic contact, the composite component in contact with moisture forms a galvanic element which can lead to rapid corrosion on the metal sheets of the component itself or on components mechanically connected to the same.

### SUMMARY

The present disclosure describes a composite component in which the risk of forming a galvanic cell is reduced. According to a configuration of the present disclosure, a composite component include a light metal layer, a steel sheet layer and an adhesive layer electrically insulating the light metal layer and the steel sheet layer against one another. Forming the metal sheet layers during roll forming is limited to bending while stretching of the material takes place to a negligible extent at the most. The adhesive layer between light metal layer and steel sheet layer of necessity lies on or near the neutral fiber of the composite that the risk of breaking the adhesive layer and establishing contact between the metal sheets during the roll forming is negligibly small.

Such a composite component is suitable to form a sill. Since the outside of the composite component is exposed to the weather with greater probability than the inside, the outside in particular can be practically formed by the favorably corrosion-resistant light metal layer, in particular of aluminum alloy.

An inner side of the composite component is preferentially accessible by way of a longitudinal slit in order to be able to optionally perform fastening of other components, depending on galvanic compatibility of the material of these other components, on the inside or the outside of the composite component.

To minimize weight, the steel sheet layer preferentially contains a high-strength, in particular press-hardening steel.

The present disclosure also contemplates a motor vehicle body in which the composite component, in particular a sill, of the type described above, is installed. In such a motor vehicle body, two body components can be connected to one another via the sill and yet be electrically insulated from one another. Accordingly, these body components which consist of different metallic materials can be prevented from forming a galvanic cell.

In particular, an underbody of steel, which imparts high mechanical load capacity to the body in the case of accidents, can be combined with a weight-saving body structure of light metal, in that the underbody is fastened to the steel sheet layer of the composite component and the body structure to the light metal layer of the composite component.

### BRIEF DESCRIPTION OF THE DRAWINGS

The present disclosure will hereinafter be described in conjunction with the following drawing figures, wherein like numerals denote like elements.

FIG. 1 is a perspective representation of a sill in a motor vehicle body according to the present disclosure;

FIG. 2 is cross-sectional view of a sill and a portion of the underbody according to the present disclosure; and

FIG. 3 is a schematic representation of a forming machine for producing the sill shown in FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

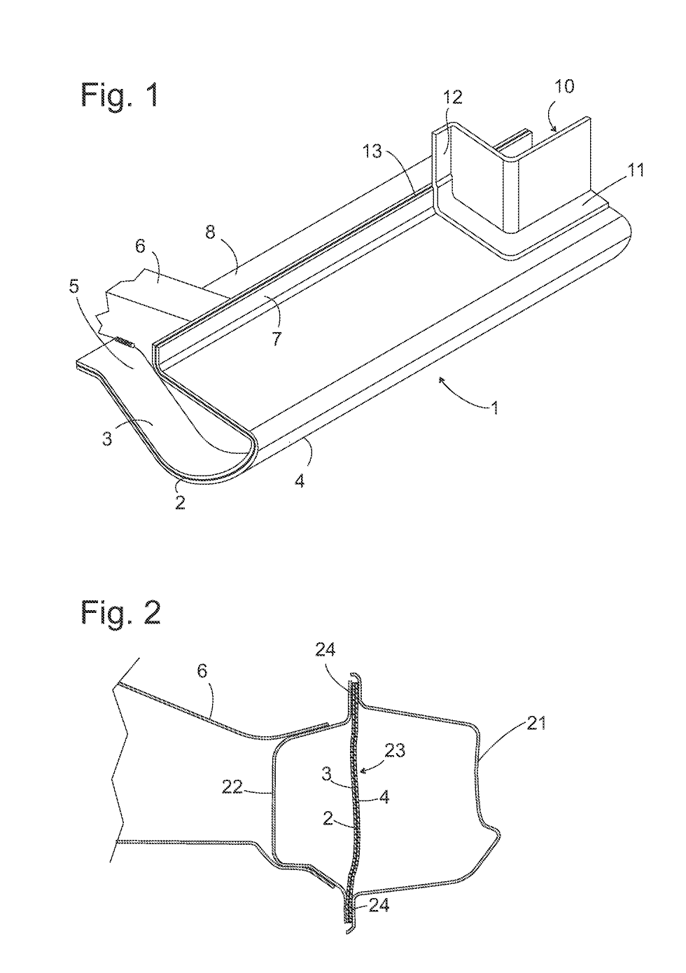

A structural member for a vehicle body in the form of a sill 1 is shown as a detail in FIG. 1. The sill 1 is a roll-formed profile of a composite material of two metal sheets 3, 4 held together by an electrically insulating adhesive layer 2 and simultaneously held spaced from one another without gap. Preferably, sheet 3 is a steel sheet and sheet 4 is a light metal sheet, in particular an aluminum alloy sheet. The sill 1 is formed by a Ω-shaped open cross section. The steel sheet 3 forms the inner side of the sill 1 and the light metal sheet 4 forms the outer side of the sill 1. The interior space of the profile is accessible via an inwardly-facing opening 5 extending over its length. An end portion of the underbody 6 is received through the opening 5 and engages the steel sheet 3 in a manner stabilizing the cross section of the sill 1. The vehicle body includes a laterally extending cross-member which is shown in FIG. 1 as an underbody 6.

The underbody 6 produced from steel is welded, at least along an upper and lower edge region 7 and 8 respectively of the sill 1, on which the steel sheet 3 is exposed and easily accessible, to the latter. In order to avoid overheating of the adhesive layer 2 during the welding, fastening the underbody 6 or its cross brace through spot welding or laser welding 9 is preferred for restricting heating to a region of the steel sheet 3 that is near the surface , during the brief period of the heat action.

The light metal sheet 4 that is exposed over a large area offers space for fastening parts of a body structure, here represented by a piece of a B-pillar 10. At the lower edge of the B-pillar 10, a flange 11 is formed which supports the B-pillar on the sill 1 over a large area. A flange 12 bordering thereon which extends vertically along the edge of the B-pillar 10 crosses an upper edge 13 of the sill 1, but avoids any contact with the steel sheet 3 exposed at this edge 13.

FIG. 2 shows a cross section through a sill 20 according to another configuration of the present disclosure. The sill 20 includes an outer wall 21, an inner wall 22, and an intermediate wall 23, which are welded together into a two-chamber hollow profile along flanges 24 formed on their upper and lower edges to form a closed section. The intermediate wall 23 in this case is a composite component with light metal sheet 4 facing an outer wall 21, a steel sheet 3 facing the inner wall 22 and an adhesive layer 2 connecting the metal sheets 3, 4. The outer wall 21 is formed from the same light metal as the metal sheet 4 and welded to it via the flanges 24, without touching the steel sheet 3, and forms the basis for a body structure of light metal not shown in FIG. 2. The inner wall 22, like the metal sheet 3, is produced from steel and only welded to the same. It connects the steel sheet 3 to a steel cross member of an underbody 6.

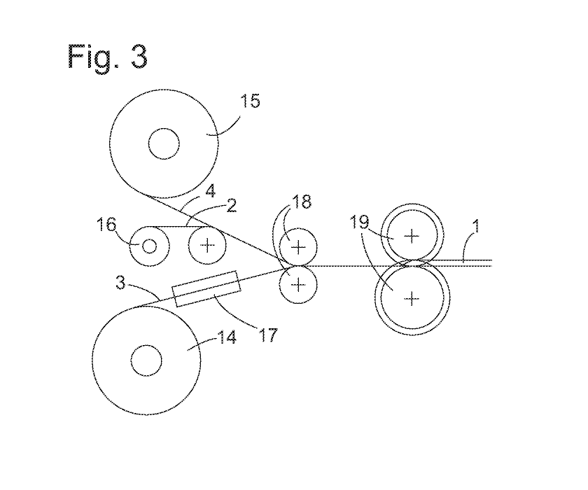

FIG. 3 schematically shows the production of the sill 1 from FIG. 1. The intermediate wall 23 of FIG. 2 can be produced in the same manner. Base materials are a steel sheet coil 14, a light metal sheet coil 15 and adhesive coil 16. In the case under consideration here, the adhesive is present in the form of a solid film which in turn is unwound from a coil 16 and rolled onto the light metal sheet 4 in order to form the layer 2. Alternatively, the adhesive could be employed in liquid form and coated onto a side of the light metal sheet 4 and wound from the coil 15 by way of a spatula or in another suitable manner.

The steel sheet 3 passes through an oven 17, in order to be heated to a temperature suitable for forming, before the metal sheets 3, 4 meet on a pair of rolls 18 and the adhesive layer 2 which comes into contact with the hot steel sheet 3 is activated.

FIG. 3 exemplarily shows a single pair of rollers 19, which is arranged directly behind the pair of rolls 18, in order to form the composite metal sheet. In order to obtain the cross-sectional shape of the sill 1 shown in FIG. 1. Multiple pairs of roller 19 can be arranged one behind the other with differently oriented axes of rotation and be passed through by the composite metal sheet one after the other.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-12. (canceled)

13. A composite component for a motor vehicle body comprising a light metal layer, a steel sheet layer and an adhesive layer electrically insulating the light metal layer and the steel sheet layer against one another, wherein the composite component is roll-formed into a structural member for the motor vehicle.

14. The composite component according to claim 13 wherein the steel sheet layer comprises a press-hardening steel.

15. The composite component according to claim 13 wherein the light metal layer forms an outwardly facing side of the structural member.

16. The composite component according to claim 13, wherein the structural member defines a Ω-shaped open cross section with a longitudinal opening providing access to an interior space of the composite component.

17. The composite component according to claim 13, wherein the structural member is formed into a sill.

18. A sill for a motor vehicle body comprising a composite component according to claim 13 and further comprising a second component joined together to form a closed sectional profile.

19. The sill according to claim 18, wherein the second component comprises a steel component fastened to the steel sheet layer.

20. The sill according to claim 18, wherein the second component comprises a light metal component fastened to the light metal layer.

21. A vehicle body comprising the composite component of claim 13, wherein the structural member forms a sill of the vehicle body.

22. The vehicle body according to claim 21, further comprising first and second body components connected to one another with the composite component such that the first and second body components are electrically insulated from one another.

23. The vehicle body according to claim 21, further comprising a steel underbody component fastened to the steel sheet layer of the composite component.

24. The vehicle body according to claim 21, further comprising a light metal body structure fastened to the light metal layer of the composite component.
